(19) United States
(12) Patent Application Publication
(10) Pub. No.: US 2015/0262255 A1
(43) Pub. Date: Sep. 17, 2015

(54) SEARCH MONETIZATION OF IMAGES EMBEDDED IN TEXT

(71) Applicant: NetSeer, Inc., Mountain View, CA (US)

(72) Inventors: Nima Khajehnouri, Los Angeles, CA (US); Behnam Rezaei, Santa Clara, CA (US); Dennis Clerke, Elfin Forest, CA (US); Sanjiv Ghate, Sunnyvale, CA (US); Riccardo Boscolo, Culver City, CA (US); Marcus Tylutki, San Jose, CA (US); Vwani Roychowdhury, Los Angeles, CA (US)

(21) Appl. No.: 14/656,653

(22) Filed: Mar. 12, 2015

Related U.S. Application Data
(60) Provisional application No. 61/952,077, filed on Mar. 12, 2014.

(51) Int. Cl. G06Q 30/02; G06F 17/30

(52) U.S. Cl. CPC G06Q 30/0275; G06F 17/30247; G06Q 30/0276; G06Q 30/0269

(57) ABSTRACT

Methods and systems for integrating images with the associated text-based content signals and data about users' preferences to determine an image or user intent. Methods and implementations for monetizing these images is also described.

### PRIORITY

The present invention claims priority to U.S. Provisional Application No. 61/952,077, entitled “A Method for Search Monetization of Images Embedded in Text,” filed Mar. 12, 2014, the entirety of which is hereby incorporated by reference.

### BACKGROUND

1. Field

The present disclosure relates generally to systems and methods for determining the context of an image embedded in text and search monetization of the images.

2. Related Art

There has been an explosion in visual content on the Internet. A combination of images and text has become the staple for content design at publisher sites across the web. This sea change has been fueled in part by the recent advances in hardware and software tools and infrastructure, which make the delivery and management of images and videos affordable and seamless.

Additional reasons may drive the explosion in visual content on the Internet. For example, the enhancement in user experience and engagement may be result from the fact that 90% of information transmitted to the brain is visual, and the brain processes visuals 60,000 times faster than text. Another reason for this improvement may be that pictures interact with text to produce levels of comprehension and memory that can exceed what is produced by text alone. For example, it has been found that 40% of people respond better to visual information than plain text, and publishers who use infographics grow in traffic an average of 12% more than those who don't. In another example of visual content driving user engagement online, one month after the introduction of Facebook timeline for brands, visual content—photos and videos—saw a 65% increase in engagement.

This integration and proliferation of visual content implies that a lot of the real estate on a publisher's page is being devoted to visual content. Naturally, the question arises as to how to monetize such intent-rich objects. There is a long history of (i) monetizing both the intent encoded in the text of a page and (ii) utilizing the real estate occupied by the text as extra space for advertisement. For example, Google's AdSense and related products and NetSeer's Concept Links (CL) products extract the context of a webpage and translate them into search ads or search suggestions, which are displayed in a separate unit of the webpage adjacent to the content. Information about Netseer's Concept Links products can be found, for example, in U.S. Pat. No. 8,380,721, the entirety of which is hereby incorporated by reference. Other products, such as in-text links, underscore certain words and phrases, and when a user “mouses over”, i.e., puts the cursor on the linked region, it displays a pop-up window with an ad-creative in it. These pop-up windows are linked to the advertisers' landing pages. Thus, new ad-space is created dynamically based on real-time user action.

Motivated by the success of text-based ads on content pages, a number of commercial entities have tried to emulate a similar framework for image monetization. For example, a target image is tagged with potentially multiple markers, and if a user “mouses over” these markers then an advertisement creative is dynamically displayed. Usually, these markers are manually placed and they target distinct objects in the image. For example, given a female celebrity image, the markers would be put on her dress, or earrings or shoes and other apparel worn by her - the related dynamic ads will be from apparel and accessory vendors. In other implementations, the whole image is tagged, and when a user places her cursor on the image, a text ad is overlaid on the image, which stays displayed on a portion of the image until the user decides to close the overlaid ad unit.

Such products and their implementations face multiple challenges. Images have to be primarily manually tagged, and the related ads or links have to be manually customized to the publisher site the image appears in. Image processing and computer vision algorithms are still deficient in identifying objects in images in an automated manner. Another challenge is that an advertisement network has to be created that provides the “demand side” (i.e., advertisers willing to and paying for displaying their ads) supply. This is a capital-intensive process requiring considerable investment of both capital and human resources over multiple years. Yet another challenge is that the images by themselves do not fully convey the intent signal of the content of the page. It is the combination of several signals, including the image, the context of its embedding (as captured by the associated text and its meaning), and the intent profile of the individual user browsing the page, that as a whole captures the intent of a user browsing the page. Thus, the same image, e.g., displaying a juicy burger, could be embedded in (i) a page talking about gourmet burgers, or (ii) a page talking about the health risks of eating fast food. Though the image is the same, the intent signals of the pages are very different. In the first page, an intent-capturing ad associated with the image could focus on gourmet burgers, while in the second page, it could focus on cholesterol checkups and means for losing weight.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

In one embodiment, a computer-implemented method is disclosed that includes integrating information selected from the group consisting of one or more of: (i) metadata associated with an image, (ii) textual content of a webpage in which the image is embedded, (iii) search queries of users that lead to the webpage and other metadata about the webpage in which the image is embedded, and (iv) metadata and textual description of other images that are also included in the webpage; analyzing the integrated content using a concept graph to extract concepts and related contexts that capture the intent of users visiting the page; determining at least one of a list of search suggestions or an advertisement from the identified concepts; and creating a display unit with the list of search suggestions, or the advertisement. The advertisement display unit, in addition to being a list of search suggestions, could be one or more text based advertisement units (for example, obtained from a sponsored search feed by inputting one or more of the search suggestions) or an advertisement creative (conventionally referred to as banner ads).

The method may further include analyzing the integrated content using structured databases. The structured databases may be one or more of an entity graph and a geo-location database.

The display unit may be an in-image display unit.

The method may further include tailoring and customizing the in-image display unit to accommodate specific requirements of an advertiser. The method may further include tailoring and customizing the in-image display unit to accommodate specific requirements of the publisher of the webpage. The method may further include tailoring and customizing the in-image advertisement display unit to target the user viewing the webpage.

The method may further include analyzing the integrated content using automated language processing.

The image metadata may be a human-generated text description of the image. The image metadata may be objects and scenes identified by a machine or a computer vision platform that automatically processes the image.

The concept graph represents concepts, concept metadata, and relationships between the concepts.

The method may further include linking the display unit to the image. The display unit may be displayed to a user when the user mouses over the image. The display unit may be dynamically overlaid over a portion of the image.

The method may further include displaying the display unit as an in-slide display unit, where the display unit is shown instead of an image, when a user browses a set of images sequentially. Thus, the display unit is dynamically embedded within an ordered set of images (i.e., a slide show) and displayed when its turn comes in the sequence.

The method may further include displaying the display unit as an IAB (Interactive Advertising Bureau) display unit adjacent to the associated image.

The method may further include displaying the display unit on a mobile platform, including a mobile browser or a mobile application, and being tailored to the specifics of the screen size and other attributes of such devices.

Each search suggestion in the display unit may be linked to a landing page. The landing page may be delivered to the user when the user clicks on a search suggestion in the display unit. The landing page may be dynamically populated with search advertisements for the clicked search suggestion. A search advertisement feed may be used to dynamically populate the search advertisements. The method may further include tracking search advertisements clicked by the user.

Analyzing the integrated content may further include analyzing user behavior profile data. The user behavior profile data may include demographic information, search history, browsing history, and recent purchase history. The method may further include customizing the search suggestions for the user. The method may further include collecting data about a user's interaction with the image using the display unit.

The advertisement may be a contextually targeted advertisement. The contextually targeted advertisement may be a display advertisement or a text advertisement.

The intent may be at least one of user intent and image intent.

In accordance with another embodiment of the invention, a system is disclosed that includes memory to store a concept map; and a processor in communication with the memory, the processor to integrate information selected from the group consisting of one or more of: (i) metadata associated with an image, (ii) textual content of a webpage in which the image is embedded, (iii) search queries of users that lead to the webpage and other metadata about the webpage in which the image is embedded, and (iv) metadata and textual description of other images that are also included in the webpage; analyze the integrated content using a concept graph to extract concepts and related contexts that capture the intent of users visiting the page; determine a list of search suggestions or an advertisement from the identified concepts; and create a display unit with the list of search suggestions or the advertisement.

In accordance with a further embodiment, a computer-implemented method is disclosed that includes for each impression of a webpage containing an image, placing the image on a supply side of an online advertisement exchange, wherein the image is tagged with one or more intent signals, the one or more intent signals comprising a user identifier, a user intent signal and an image intent signal; publishing the image and the one or more intent signals to a plurality of bidders for an auction on the online advertisement exchange; allowing a set of minimum bid values to be specified for each impression; and dynamically determining one of the set of minimum bid values for each particular impression to maximize revenue.

The method may further include generating a monetization profile for the image.

Dynamically determining one of the set of minimum bid values may include dynamically estimating f(Ci) and p(Ci) or b(Ci) for each of a plurality of Cis, wherein Ci is the minimum bid value, f(Ci) is a fill rate, p(Ci) is payout and b(Ci) is a received bid; and applying a search algorithm is used on the estimates to identify the Ci's that maximizes Σᵢ₌₁^{K}Ni*f(Ci)*p(Ci) where Ni+1=Ni(1−fi), where where Ni is the impression frequency.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 is a schematic diagram of a system for determining search suggestions for an image embedded in a webpage in accordance with one embodiment of the invention;

FIG. 2 is a flow diagram of a process for providing search suggestions for images embedded in a webpage in accordance with one embodiment of the invention;

FIG. 3 is a schematic diagram of an exemplary image;

FIG. 4 is a schematic diagram of an exemplary webpage;

FIG. 5 is a schematic diagram of concepts derived from the exemplary webpage;

FIG. 6 is a schematic diagram of contexts determined from the concepts;

FIG. 7 is schematic diagram of an exemplary webpage with a display unit;

FIG. 7A is a detailed diagram of an image with the display unit;

FIG. 8 is a schematic diagram of an exemplary pop-up window with the search suggestions; and

FIG. 9 is a schematic diagram of a computer system in accordance with one embodiment of the invention.

### DETAILED DESCRIPTION

Systems and methods for integrating images with the associated text-based content signals and data about users' preferences. This includes monetization of the advertisement real estate provided by the images using multiple signals and combinations thereof, including (i) contextually targeted advertisements (“ads”) based on the intent of the image in the context of the meta-data, web page, text and domains that the image is embedded in, (ii) ads targeted by combining contextual signals with user profiles and other user intent signals compiled from user activities both on- and off-line, and (iii) ads targeted primarily based on user intent as practiced by many “retargeting” vendors on online exchanges. The contextually targeted ads include both display and text ads (such as Concept Links, and one-click text ads as obtained from sponsored search feeds). Thus, embodiments of the invention provide a method and implementation of monetizing images that overcome many of the limitations of existing approaches.

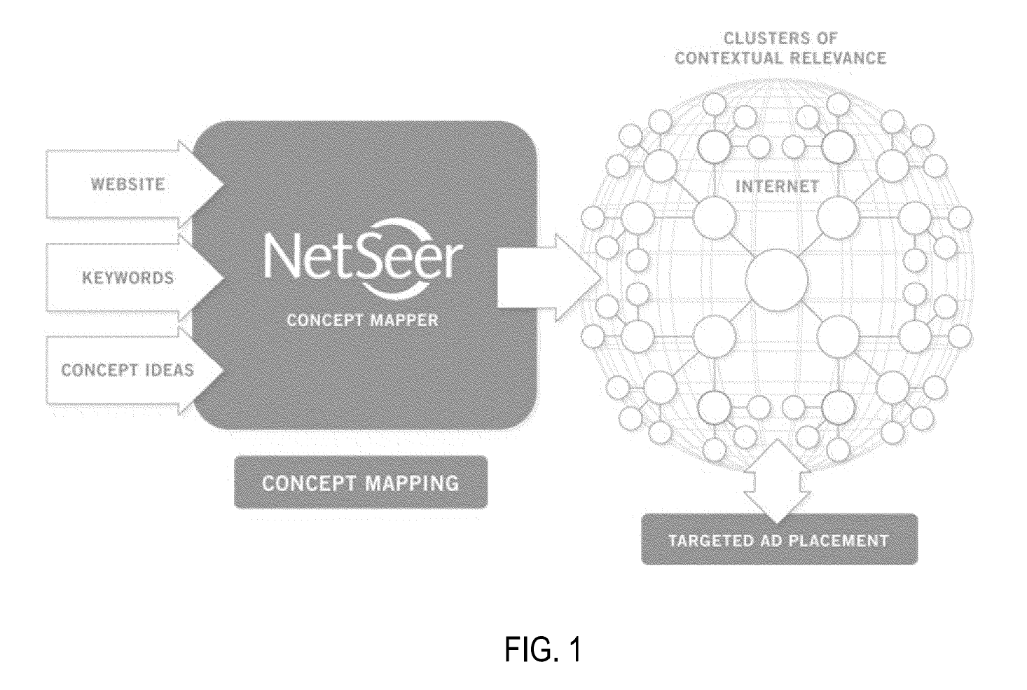

FIG. 1 illustrates a system for monetizing images embedded in pages. The concept mapper classifies content, including websites, keywords and concept ideas, to decipher the intent of a web page. The intent is embodied in a concept map that includes clusters of contextual relevance. The intent determined from the concept map can be used for targeted advertisement placement. Additional details regarding the concept mapper, concept map and targeted advertisement placement are described in U.S. Pat. Nos. 7,958,120, 8,301,617, 8,838,605, 8,825,654, 8,380,721, 8,825,657 and 8,843,434 and U.S. patent application Ser. Nos. 11/923,546, entitled “Methods and Apparatus for Matching Relevant Content to User Intention,” filed Oct. 24, 2007, Ser. No. 12/436,748, entitled “Discovering Relevant Concept and Context for Content Node,” filed May 6, 2009, Ser. No. 12/476,205, entitled “Behavioral Targeting for Tracking, Aggregating and Predicting Online Behavior,” filed Jun. 1, 2009, and Ser. No. 12/906,051, entitled “Generating a Conceptual Association Graph from Large-Scale Loosely-Grouped Content,” filed Oct. 15, 2010, the entireties of which are hereby incorporated by reference.

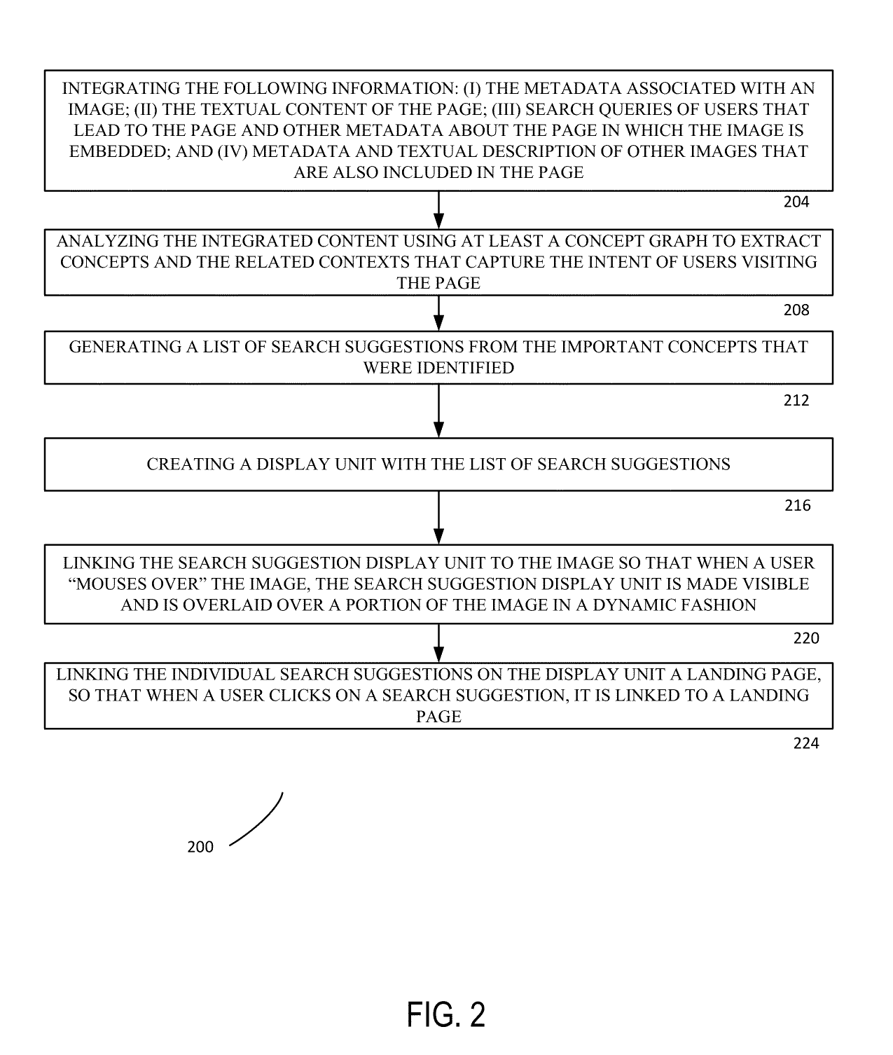

FIG. 2 illustrates an exemplary process for monetizing an image embedded in a web page.

The process 200 begins by integrating the following information: (i) the metadata associated with an image; (ii) the textual content of the page; (iii) search queries of users that lead to the page and other metadata about the page in which the image is embedded; (v) user's identification or cookie id which will be used to utilize the user's profile and intent; and (iv) metadata and textual description of other images that are also included in the page (block 204). The metadata associated with the image may include human-generated text description of the image or objects and scenes identified by a machine or a computer vision platform that automatically processes the image.

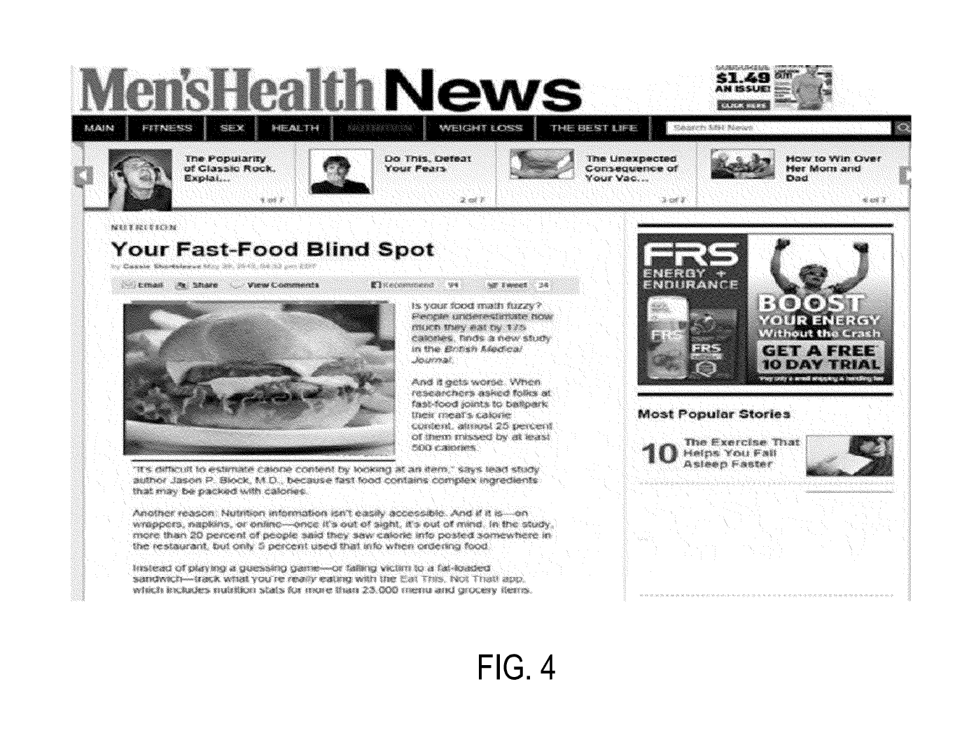

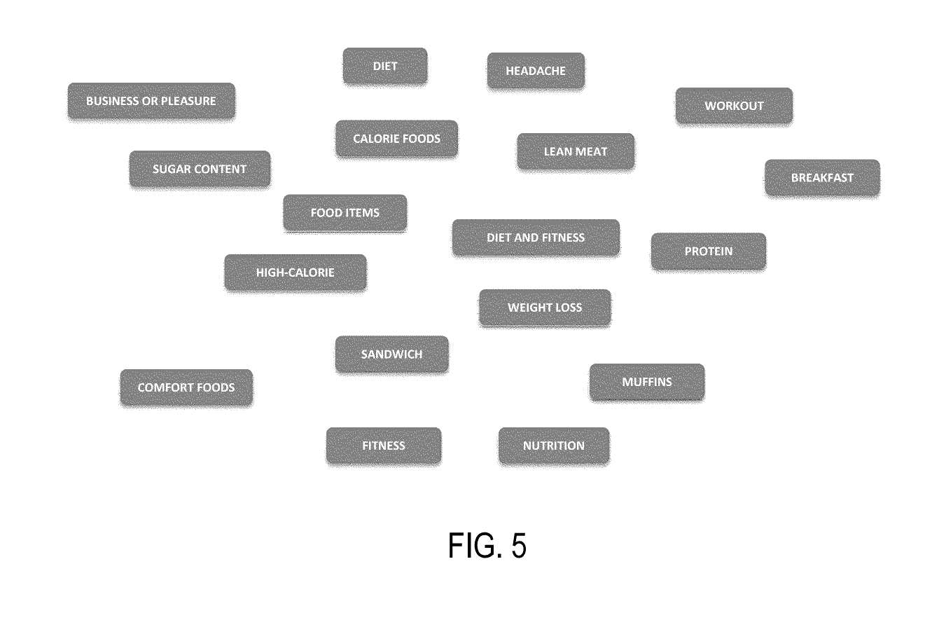

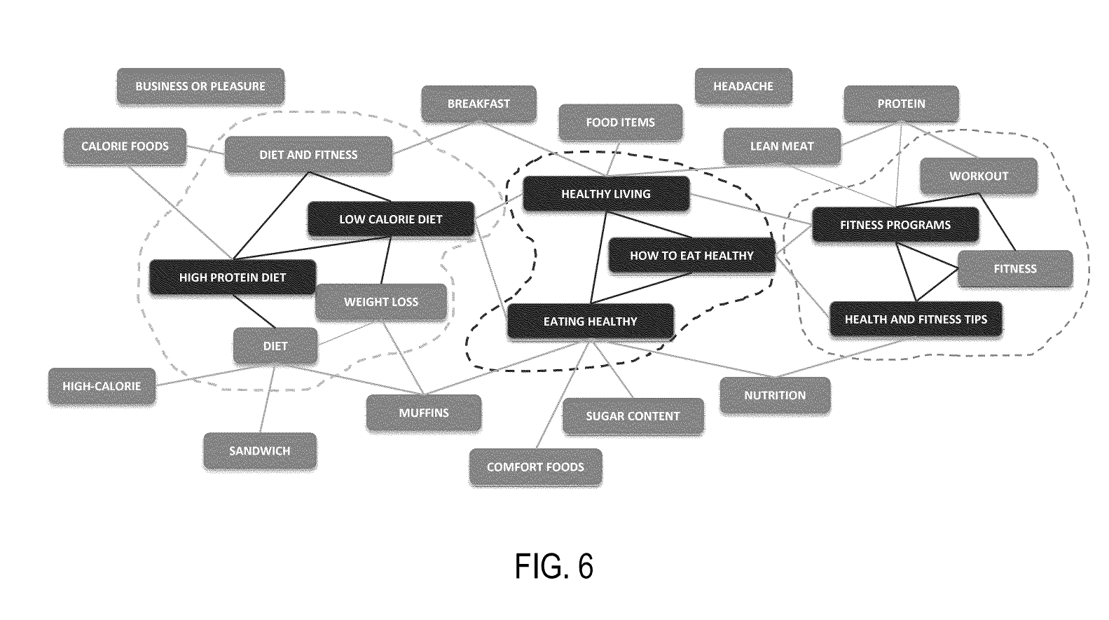

The process 200 continues by analyzing the integrated content, using the concept graph, structured databases (such as an entity graph and geo-location databases), and various other tools, such as automated language processing, to extract concepts and the related contexts that capture the intent of users visiting the page (block 208). The analysis may further include identifying important concepts and related concepts. In one particular embodiment, as illustrated in FIGS. 4, 5, and 6, an exemplary practice of this process involves multiple steps, including, (i) identifying the concepts and terms from all the sources, as mentioned in the preceding paragraphs, related to the image (e.g., FIG. 5), and (ii) using these concepts as seed nodes in a concept graph to identify different groups of concepts or contexts with similar intent (e.g., FIG. 6). The original intent signals can then be grouped into different intent groups, such as “Diets”, “Healthy Living” and “Fitness programs” in the example shown in FIGS. 4-6. An exemplary way of executing expansion of seeds nodes within a concept graph and then identifying different “knowledge dimensions” or contexts is described in U.S. Pat. No. 8,843,434, the entirety of which is hereby incorporated by reference. This expansion is advantageous because the customized knowledge dimensions or contexts can act as the high-level signals to target contextualized advertisements on the image. For example, if we know that a user is interested in Fitness Programs and has been browsing for fitness equipment, then the related ads (matching both user signal and image intent signal) could focus on various fitness related products and services, including Fitbit and other Smart Bracelets. In another scenario, when the user's intent is not very specific to only one context, then contextual advertisements covering all the different aspects of the intent space can be identified, so that any user will find something that resonates with their intent. This could avoid showing multiple ads or search suggestions from the same content or intent space and thereby missing other intent signals.

The process 200 continues by generating a list of search suggestions from the important concepts that were identified (block 212). One particular embodiment of this practice involves mapping the different intent groups and related concepts to “keywords” and “search suggestions” that have high RPM (Revenue Per Thousands Impressions) sponsored search ads associated with them. This can be accomplished again via a concept graph and a database that stores the estimates of CPC's. Such a database can be created and maintained either by accessing Search Engine application programming interfaces (APIs) that provide expected RPM's of different keywords, or by sponsored search vendors, such as NetSeer, where one has live first-hand data about the RPM's of ads related to different keywords. For example, in the Concept Links product, NetSeer serves sponsored search results for millions of keywords everyday and learns and logs all the RPM statistics. The high-RPM and intent rich keywords are also in the concept graph, and the ones that are highly related (as in network-based distance measure on the concept graph) to the intent groups or knowledge dimensions are determined. These keywords then form the core set of search suggestions. These search suggestions are then displayed and the CTR and related RPM's are measured to determine in an online and real-time manner the highest performing set of keywords for a particular image. It will be appreciated that a concept graph is not the only way of doing this. For example, other data mining tools that can capture relevant keywords to the intent of the image can be used to extract relevant search suggestions. All one needs is a measure for determining the intent-proximity or intent-distance between the concepts by using the image intent (or concepts) and the set of keywords with a large advertisement or demand base.

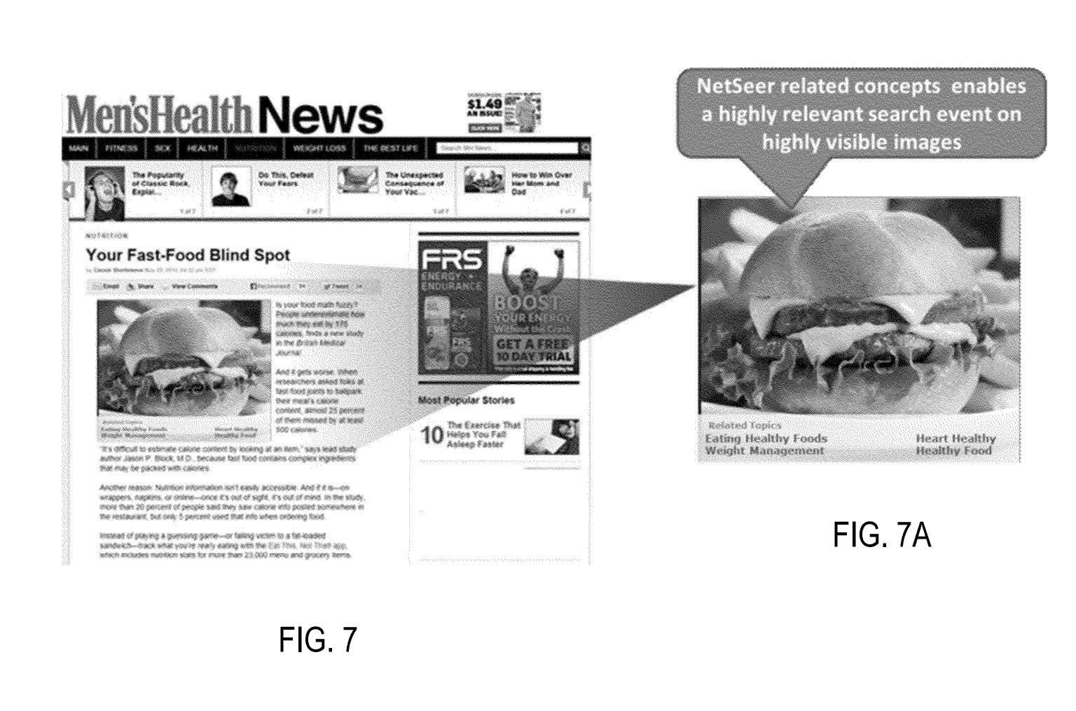

The process 200 continues by creating a display unit with the list of search suggestions or display advertisements (block 216). An exemplary display unit (or creative) is shown in 7A. It will be appreciated that the format and configuration of the display unit may differ from that shown in FIG. 7A. The search results displayed in the display unit may be sponsored search results. Thus instead of showing search suggestions, such as “Fitbit” or “Smart Bracelets”, one directly shows a sponsored text advertisement from an advertiser who has entered a bid and won the auction for say the keyword “smart bracelets”. As an alternative, the display unit may instead be created with a display advertisement.

The process 200 continues by linking the search suggestion display unit to the image so that when a user “mouses over” the image, the search suggestion display unit is made visible and is overlaid over a portion of the image in a dynamic fashion (block 220). An exemplary webpage with the display unit is shown in FIG. 7. Various options on how the advertisement display unit (which may be, but not limited to, a search suggestion unit, or a sponsored text ad unit, or a display/banner advertisement unit) is overlaid on the image and content on the publisher's page may be provided. For example, the available options include the (i) ability to change the transparency of the unit to make the overlaid portion more or less visible, (ii) allowing the user to close the display unit, (iii) putting a frequency cap on how many times the unit is display to a user during the span of preset time duration, (iv) ability to select a certain group of images based on their attributes or/and meta information, (v) ability to filter out a certain group of images on based on their attributes or/and meta information, (vi) ability to enable or disable the ad unit for particular type or group of devices such as mobile, desktop, tablet, (vii) ability to define different logics to show or hide the ad unit once the page is loaded, i.e., timer, mouse over the image, image comes to viewport, randomly, order of the image in the page, (viii) allowing publisher to place a tag inside the body of the page and all the eligible images will be detected and added to the supply side without any need from the publisher to identify those.

The display unit may also be displayed as part of a sequence of images, or in an “inslide” manner. In such a setting, a user browses through an ordered sequence of images, and the display unit is displayed (instead of an image) at certain points in this sequence. Thus, the image real estate is time multiplexed with the display ad unit (instead of being overlaid on an image or be part of a pop-up window), and the next image is shown only after the user clicks to close the display ad unit or clicks to move on to the next image in the sequence.

In another embodiment of this invention, the display unit may be placed as an IAB (Interactive Advertising Bureau) unit that accompanies the image under consideration.

It will be appreciated that display unit (or creative) can be customized for the user, publisher or advertiser. For example, the creative can be customized for targeting the users as in practiced by the “retargeting” advertisers, where the user has expressed specific intent, as say in buying a pair of shoes. In such a case, the creative can include the image of the particular shoe that the user has looked at before. The display unit can also be customized to the publishers themselves, such that the advertisement unit is tailored to match the native look and feel of the site that the image is embedded in. Likewise, the display unit can be tailored to the particular advertisers' needs, such as by matching the feed type of the advertiser. For example, eCommerce players for product listing such as eBay prefer to show carousels comprising images of their products; the publisher or the image owner can customize the in-image display units to accommodate such requests.

The process 200 continues by linking the individual search suggestions on the display unit a landing page, so that when a user clicks on a search suggestion, it is linked to a landing page (block 224). The landing page is dynamically populated with search ads for the clicked search suggestion. This search advertisement feed can be obtained from leading providers of sponsored search results. Likewise, for a display advertisement or a sponsored text advertisement unit, the landing page may be a link to the advertisement's sponsor or source.

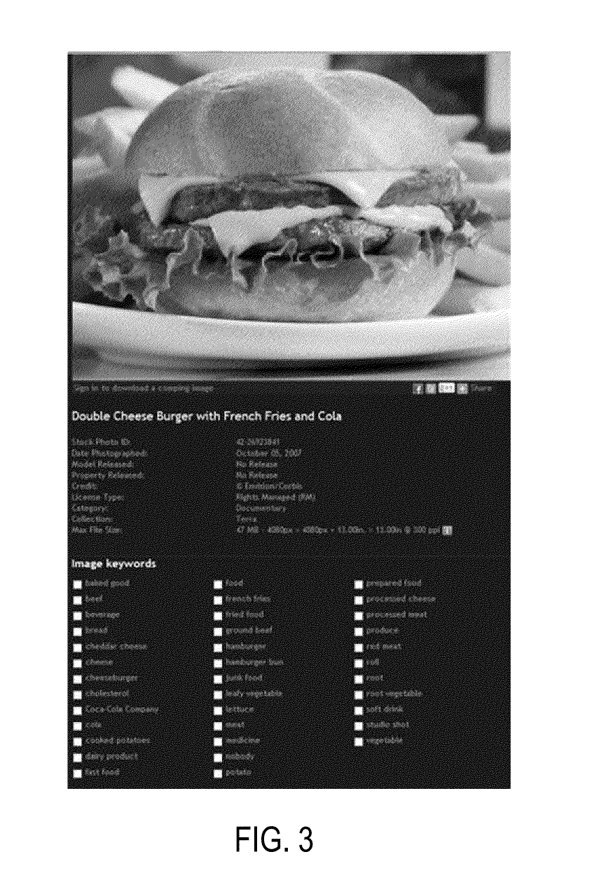

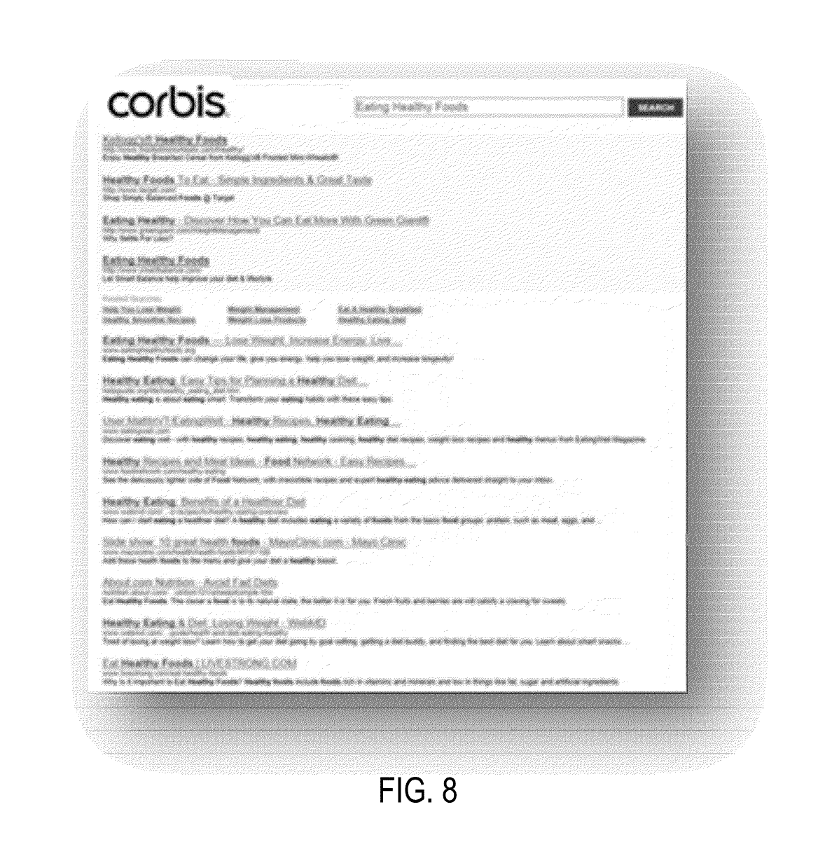

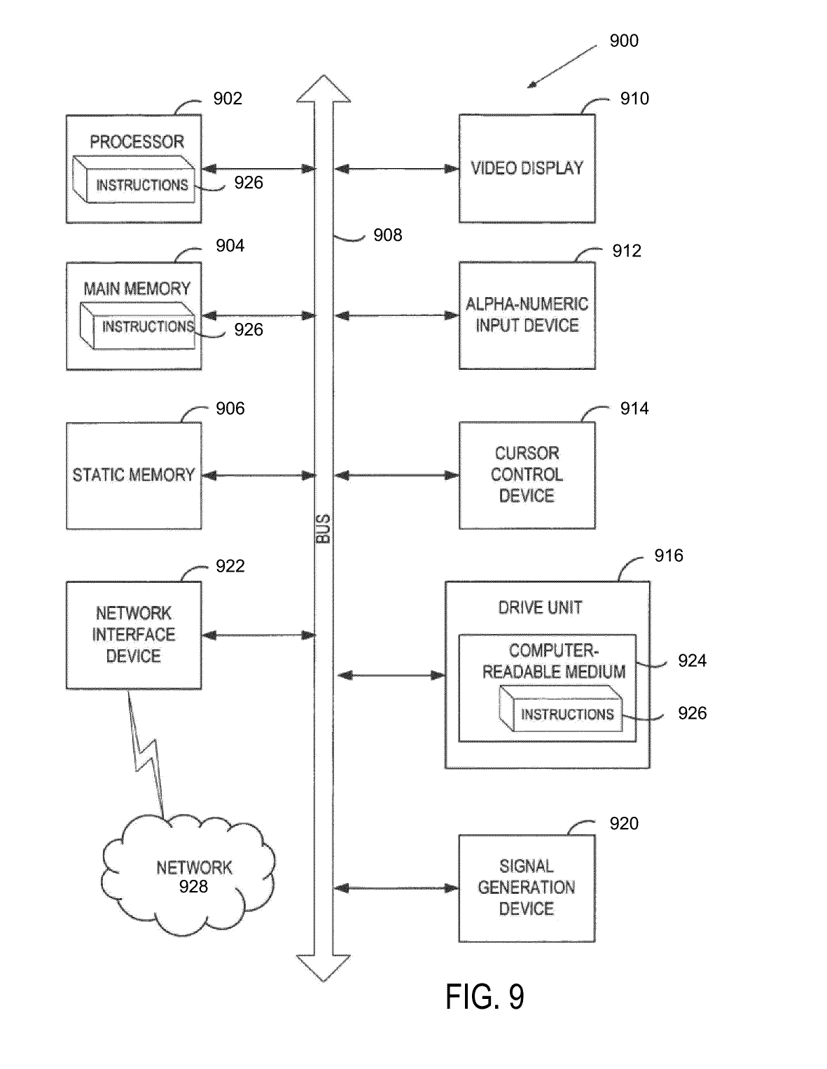

FIG. 3 illustrates an exemplary webpage with an image embedded in it. As described above, the system analyzes the image using a variety of different data to extract concepts and related concepts for the image. FIG. 4 illustrates exemplary primary concepts identified by the system from the exemplary webpage shown in FIG. 3. The system then extracts the core concepts based on relationships among the primary concepts and based on revenue optimization. FIGS. 5 and 6 illustrate exemplary core themes and concepts for the exemplary webpage shown in FIG. 3. A display unit is then generated for the image with search suggestions determined from the core themes and concepts. FIG. 7 illustrates the webpage with the search results display unit. As shown in FIG. 7A, the search results display unit is positioned just below the image itself. The related concepts identified by the system enable a highly relevant search event on highly visible images. FIG. 8 illustrates an exemplary search results landing page for the search results display unit. The search results landing page is displayed if the user clicks on one of the suggested searches in the search suggestion display unit.

In some embodiments, the search ads clicked by the user are tracked.

The user behavior profile data, e.g., demographic information, search history, browsing history, recent purchase history, may be integrated into the content analysis step described above. The search suggestions can then be customized to the user in the context of the page and the image.

The display unit can be used to collect data about a user's interaction with an image. Aggregating such data can be used to understand the value of the image to both the users and the publishers, as well as, developing profiles for the users who interact with the image. This information can be used to customize and upgrade the display unit.

Accordingly, embodiments of the invention address many of the challenges currently faced in the monetization of image units in publisher pages and create new opportunities for business. In particular, embodiments of the invention provide an automated method for tagging an intent behind an image using the concepts and intent signals inherent in the text and other data associated with the page to generate relevant and intent-capturing search suggestions for an image. While metadata manually or automatically generated for the image can be used, it is not necessary. The creator of the page provides information about the intent signals of the image by embedding it in the right context that is captured by the ancillary textual information.

The search suggestions or advertisements that are associated with the images in embodiments of the invention have an established “demand side” supply inventory that has been created by the search engines and other entities over more than a decade. The publishers can take advantage of this well established demand-side supply chain without having to create an ad network.

Another large-scale source of the “demand side” supply chain are the various Real Time Bidding (RTB) on line advertisement exchanges, such as AdX, App-Nexus, OpenX, etc. These exchanges allow one to auction off any available ad-space to the highest bidder in real time. The winner then uploads an advertisement unit (for example, traditional IAB (Interactive Advertising Bureau) display units) in real time. Embodiments of the invention are particularly suitable for monetizing images at large scale using this RTB advertisement eco-system. In one embodiment, for every impression of a page containing an image, the publisher places the in-image ad unit on the supply side of an online exchange. The image ad unit can be tagged with various “viewability” signals, such as location of the image on the page (e.g., below or above the fold), the location of the associated advertisement display unit (e.g., whether overlaid on the image, or as an “in-slide unit” or as an IAB unit) and intent signals, such as user-id, the invention-derived intent signals (as captured via concepts and key-words), and the like. In addition, the content owner can provide parameters that constrain the auction, so as to maximize the revenue generated from the auctions. For example, for each impression, the image owner (publisher or the image copyright owner) can specify the minimum bid value, often specified in terms of CPM (cost per thousand) impressions.

The exchange then utilizes all the information provided by the publisher, including, the placement information and the various intent signals and passes those to bidders on demand side. If a minimum bid value is specified by the publisher, then this is considered as well in determining whether to bid or not and by how much above the minimum. A winner is determined by the auctioneer based on their auction strategy. The winner then uploads the related display unit completing the chain. The bids could be based on CPM (cost per thousand impressions) or CPA (cost per action) strategies, but it is the responsibility of the bidder to manage its budget and the demand side. The availability of the RTB exchanges, and the integration of embodiments of the invention with the exchanges provide an unprecedented opportunity for the publishers to monetize their image content and also build up a monetization profile for their images. Similarly, the image copyright holders can now tag their images with monetizable intent and profile how users interact with their images.

The process explained above is for a given exchange and one auction request. In practice, the given impression is offered to a marketplace ecosystem having a number of sources or networks, which could include internal managed demand advertisers (e.g., Media Product, CL Product), other exchanges (e.g., ADX, OpenX, AppNexus, etc.) external buyers (e.g., e-commerce platforms, such as eBay and Amazon), CPA offered private marketplace bidders, or any other medium that has access to a platform for automatically bidding on the impression. Embodiments of the invention also provide a strategy for the image owner or webpage publisher to maximize his revenue by explicitly and dynamically setting the minimum bid value for the impressions. One such strategy could be termed as the “waterfall” strategy. In these marketplace auctions, a minimum CPM floor is set for each of the sources. A first demand source bids on the impression above its set CPM floor. If the first demand source doesn't win the impression, then it is sent to a second source. The second source repeats the same process as the first source, and again if the second source does not win the impression, it will go to another source. The final source in the waterfall may choose to not serve any advertisement or show an advertisement with a very low CPM. Each given source or network has a particular fill rate at a CPM floor. Embodiments of the invention are advantageous because they optimize the CPM floor values and choose the best order of networks within the sequence of bids. Most of the demand networks are second-price auctions and embodiments of the invention choose the optimal sequence of networks and their floor CPM price to achieve maximum yield.

Specifically, the waterfall strategy involves two parameters: Let f(Ci) be the fill-rate at the CPM floor, i.e., the percentage of impressions that receive a winning bid, and p(Ci) be payout when the minimum bid value is set at Ci (the common model is second-price auction and it's great or equal than the CPM floor) and Let R(Cᵢ)˜f(Cᵢ)*p(Ci) be the average revenue per impression (note the revenue is 0 when there is no fill or bidder at all satisfying the minimum bid) as obtained from the winner when the impression is placed on the exchange for CPM floor Ci. p(Ci) can be approximated as b(Ci)*Ci where b(Ci)>=1, b(Ci) being the received bid amount. Note that if Ci is set very high then a lot of bidders may not bid at all and hence fi is very low, and hence the effective revenue per impressions, f(Ci)*p(Ci), is low. On the other hand if Ci is set too low, then f(C,) will be close to 1 and, even though the image wins an advertisement almost all the time, the effective revenue is again low. Hence, the revenue maximization problem consists in first finding a set of K minimum bid values, C₁>C₂>C₃ . . . >C_{K}. The minimum bid value is set to Ci, when the expected revenue per impression is f(Cᵢ)*p(Ci).

In one embodiment of this revenue maximization strategy, an online (real-time) and dynamic optimization algorithm is used. For example, in the discovery phase, the algorithm sweeps through a set of Ci's starting with a maximum value of Cl, with a decrement of I, and dynamically estimating f(Ci) and p(Ci) or b(Ci) for each Ci. Once this table is filled up with these discovery sets, then a search algorithm is used on this table to obtain the best Ci's that maximizes Σᵢ₌₁^{K}Ni*f(Ci)*p(Ci) where Ni+1=Ni(1−fi) and where Ni is the impression frequency. The dynamically created table of Ci, p(Ci) or b(Ci) and f(Ci) can be periodically updated for each publisher and exchange.

The problem of images having multiple intent signals and therefore the problems that arise with the practice of pre-tagging an image with a pre-defined set of text tags do not arise with the systems and processes described herein. Any metadata information that is available about the image may be used, but the context of the page is used to determine the intent signals of the image.

Embodiments of the invention enable a different and potentially much more profitable and scalable business model for image copyright owners. The current practice of image copyrighters is to charge a one-time licensing fee for the use of their image at a publisher's site. Embodiments of the invention now enables them to (i) enable paid advertisement on display units (including, but not limited to, search suggestion units, or sponsored text advertisement units, or display or banner advertisement units) on or associated with (including but not limited to, in-slide display units and IAB units) these images, which transform these images into a source of continuous revenue generation based on traffic at the publisher's site. Thus, in addition to a licensing fee they can get a share of the revenue generated from users clicking on the sponsored advertisements in the landing page, after they have clicked on one of the search suggestions; (ii) allow the image owners to get the user data generated from interactions with the images on the publishers' sites, which can be used to target ads and serve content to users in other parts of the online advertisement targeting eco-system, (iii) improve the monetization of the images based on the data gathered during the lifetime of its deployment, (iv) use the aggregated data to set up a self-served and automated system for publishers to pick the most relevant and most revenue generating images based on the content and the context of the page that the publishers want to use images for; and, (v) allow the creation of an exchange for image monetization where the images come pre-tagged with search suggestion display units and other data aggregated about the images.

The image copyright owners can determine which types of users resonate with which types of images based on user interaction with the images (i.e., user signals). For example, an image of an elderly couple may strike a chord with women over the age of 60, or an image of Harry Potter, Lord of the Rings or other fantasy-type images may resonate with millennials. A user profile or user signal can be generated based on the image content, which can then be used to identify relevant advertisements. Although embodiments of the invention may use image intent based targeting of ads or combinations of image intent and user signal based targeting, it will also be appreciated that user signals alone may be used to target ads. In other words, the ad space may be used to match a contextual ad to the user based on the user profile.

FIG. 8 shows a diagrammatic representation of machine in the exemplary form of a computer system 800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 800 includes a processor 802 (e.g., a central processing unit (CPU), a graphics processing unit (GPU) or both), a main memory 804 (e.g., read only memory (ROM), flash memory, dynamic random access memory (DRAM) such as synchronous DRAM (SDRAM) or Rambus DRAM (RDRAM), etc.) and a static memory 806 (e.g., flash memory, static random access memory (SRAM), etc.), which communicate with each other via a bus 808.

The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 820 (e.g., a speaker) and a network interface device 822.

The disk drive unit 816 includes a computer-readable medium 824 on which is stored one or more sets of instructions (e.g., software 826) embodying any one or more of the methodologies or functions described herein. The software 826 may also reside, completely or at least partially, within the main memory 804 and/or within the processor 802 during execution thereof by the computer system 800, the main memory 804 and the processor 802 also constituting computer-readable media.

The software 826 may further be transmitted or received over a network 828 via the network interface device 822.

While the computer-readable medium 824 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, and optical and magnetic media.

One or more of the methodologies or functions described herein may be embodied in a computer-readable medium on which is stored one or more sets of instructions (e.g., software). The software may reside, completely or at least partially, within memory and/or within a processor during execution thereof. The software may further be transmitted or received over a network.

It should be noted that the systems, methods and applications disclosed herein are illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

It should be noted that the invention is illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

The term “computer-readable medium” should be taken to include a single medium or multiple media that store the one or more sets of instructions. The term “computer-readable medium” shall also be taken to include any medium that is capable of storing, encoding or carrying a set of instructions for execution by a machine and that cause a machine to perform any one or more of the methodologies of the present invention. The term “computer-readable medium” shall accordingly be taken to include, but not be limited to, solid-state memories, and optical and magnetic media.

Embodiments of the invention have been described through functional modules at times, which are defined by executable instructions recorded on computer readable media which cause a computer, microprocessors or chipsets to perform method steps when executed. The modules have been segregated by function for the sake of clarity. However, it should be understood that the modules need not correspond to discreet blocks of code and the described functions can be carried out by the execution of various code portions stored on various media and executed at various times.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The invention has been described in relation to particular examples, which are intended in all respects to be illustrative rather than restrictive. Those skilled in the art will appreciate that many different combinations of hardware, software, and firmware will be suitable for practicing the present invention. Various aspects and/or components of the described embodiments may be used singly or in any combination. It is intended that the specification and examples be considered as exemplary only, with a true scope and spirit of the invention being indicated by the claims.

1. A computer-implemented method comprising:
integrating information selected from the group consisting of one or more of: (i) metadata associated with an image, (ii) textual content of a webpage in which the image is embedded, (iii) search queries of users that lead to the webpage and other metadata about the webpage in which the image is embedded, and (iv) metadata and textual description of other images that are also included in the webpage;
analyzing the integrated content using a concept graph to extract concepts and related contexts that capture the intent of users visiting the page;
determining at least one of a list of search suggestions or an advertisement from the identified concepts; and
creating a display unit with the list of search suggestions or the advertisement.

2. The method of claim 1 further comprising analyzing the integrated content using structured databases.

3. The method of claim 1, wherein the display unit is an in-image display unit.

4. The method of claim 1, wherein the display unit is an in-inslide display unit, where the display unit is embedded as part of a sequence of images.

5. The method of claim 1, wherein the display unit is an IAB (Interactive Advertising Bureau) display unit.

6. The method of claim 1, wherein the display unit is displayed on a mobile platform, including a mobile browser or a mobile application, and being tailored to the specifics of the screen size and other attributes of such devices.

7. The method of claim 3, further comprising tailoring and customizing the in-image display unit to accommodate specific requirements of an advertiser.

8. The method of claim 3, further comprising tailoring and customizing the in-image display unit to accommodate specific requirements of the publisher of the webpage.

9. The method of claim 3, further comprising tailoring and customizing the in-image advertisement display unit to target the user viewing the webpage.

10. The method of claim 2, wherein the structured databases comprise one or more of an entity graph and a geo-location database.

11. The method of claim 1, further comprising analyzing the integrated content using automated language processing.

12. The method of claim 1, wherein the image metadata comprises a human-generated text description of the image.

13. The method of claim 1, wherein the image metadata comprises objects and scenes identified by a machine or a computer vision platform that automatically processes the image.

14. The method of claim 1, wherein the concept graph represents concepts, concept metadata, and relationships between the concepts.

15. The method of claim 1, further comprising linking the display unit to the image.

16. The method of claim 8, wherein the display unit is displayed to a user when the user mouses over the image.

17. The method of claim 9, wherein the display unit is dynamically overlaid over a portion of the image.

18. The method of claim 1, wherein each search suggestions in the display unit is linked to a landing page.

19. The method of claim 18, wherein the landing page is delivered to the user when the user clicks on a search suggestion in the display unit.

20. The method of claim 18, wherein the landing page is dynamically populated with search advertisements for the clicked search suggestion.

21. The method of claim 20, wherein a search advertisement feed is used to dynamically populate the search advertisements.

22. The method of claim 15, further comprising tracking search advertisements clicked by the user.

23. The method of claim 1, wherein analyzing the integrated content further comprises analyzing user behavior profile data.

24. The method of claim 23, wherein the user behavior profile data comprises demographic information, search history, browsing history, and recent purchase history.

25. The method of claim 23, further comprising customizing the search suggestions for the user.

26. The method of claim 1, further comprising collecting data about a user's interaction with the image using the display unit.

27. The method of claim 1, wherein the advertisement is a contextually targeted advertisement.

28. The method of claim 27, wherein the contextually targeted advertisement comprises a display advertisement or a text advertisement.

29. The method of claim 1, wherein the intent comprises at least one of user intent and image intent.

30. A system comprising:
memory to store a concept map; and
a processor in communication with the memory, the processor to integrate information selected from the group consisting of one or more of: (i) metadata associated with an image, (ii) textual content of a webpage in which the image is embedded, (iii) search queries of users that lead to the webpage and other metadata about the webpage in which the image is embedded, and (iv) metadata and textual description of other images that are also included in the webpage;
analyze the integrated content using a concept graph to extract concepts and related contexts that capture the intent of users visiting the page; determine a list of search suggestions or an advertisement from the identified concepts; and create a display unit with the list of search suggestions or the advertisement.

31. A computer-implemented method comprising:
for each impression of a webpage containing an image, placing the image on a supply side of an online advertisement exchange, wherein the image is tagged with one or more intent signals, the one or more intent signals comprising a user identifier, a user intent signal and an image intent signal;
publishing the image and the one or more intent signals to a plurality of bidders for an auction on the online advertisement exchange;
allowing a set of minimum bid values to be specified for each impression; and
dynamically determining one of the set of minimum bid values for each particular impression to maximize revenue.

32. The method of claim 31, further comprising placing the image on a real time bidding advertisement exchange.

33. The method of claim 32, further comprising providing the image to a plurality of bidding sources, and wherein the image and the one or more intent signals is published to the plurality of bidding sources.

34. The method of claim 33, wherein the plurality of bidding sources are selected from the group consisting of internal managed demand advertisers, real time bidding advertisement exchanges, external buyers, private marketplace bidders, and mediums that have access to automatically bid on the impression.

35. The method of claim 33, wherein the image is provided to the plurality of sources using a waterfall strategy.

36. The method of claim 31, further comprising generating a monetization profile for the image.

37. The method of claim 31, wherein dynamically determining one of the set of minimum bid values comprises:
dynamically estimating f(Ci) and p(Ci) or b(Ci) for each of a plurality of Cis, wherein Ci is the minimum bid value, f(Ci) is a fill rate, p(Ci) is payout and b(Ci) is a received bid; and
applying a search algorithm is used on the estimates to identify the Ci's that maximizes Σᵢ₌₁^{K}Ni*f(Ci)*p(Ci) where Ni+1=Ni(1−fi), where where Ni is the impression frequency.
